(19) United States
(12) Patent Application Publication
(10) Pub. No.: US 2008/0089103 A1
(43) Pub. Date: Apr. 17, 2008

(54) HIGH EFFICIENCY DC TO AC POWER CONVERTER

(76) Inventors: Cheng-Chia HSU, Chupei City (TW); Yun-Ching WU, Hsinchu City (TW)

Correspondence Address: HDSL, 4331 STEVENS BATTLE LANE, FAIRFAX, VA, 22033, US

(21) Appl. No.: 11/953,813

(22) Filed: Dec. 10, 2007

Related U.S. Application Data
(63) Continuation-in-part of application No. 11/150,200, filed on Jun. 13, 2005, now abandoned.

(51) Int. Cl. H02M 7/5387; H02M 7/537

(52) U.S. Cl. 363/132; 363/131

(57) ABSTRACT

A high efficiency DC to AC power converter capable of achieving zero voltage switching by provision of an inductive impedance in a conversion circuit. The inductive impedance takes a form of an inductance connected in series with a capacitor. In addition, the inductive impedance may be provided in a half-wave or full-wave conversion circuit for the high efficiency DC to AC power converter.

### RELATED APPLICATIONS

This application is a continuation-in-part of U.S. patent application Ser. No. 11/150,220, filed on Jun. 13, 2005.

### BACKGROUND OF THE INVENTION

1. Field of the Invention

The present invention relates to a high efficiency direct current (DC) to alternating current (AC) power converter and particularly to a high efficiency DC to AC power converter capable of achieving zero voltage switching by provision of an inductive impedance in a conversion circuit.

2. Description of the Prior Art

FIG. 1 and FIG. 2 respectively show a half-wave and a full-wave conversion circuit for a conventional direct current (DC) to alternating current (AC) power converter. For both the half-wave or full-wave conversion circuits, a lamp A therein is capacitive. Power is provided to the load, lamp A, through switch B, it being converted from DC power to AC power. Thus, the converted AC power is also capacitive. According to the related knowledge, the capacitive load may not achieve zero voltage switching in the DC to AC converter and thus switching loss is increased and power conversion efficiency is adversely influenced. To see a relationship of voltage versus current of such a conversion circuit, FIG. 3 may be referred to.

Therefore, the above mentioned conversion circuits are inherent with some shortcomings and required to be improved.

In view of these problems encountered in the prior art, the Inventors have paid many efforts in the related research and finally developed successfully a high efficiency DC to AC power converter, which is taken as the present invention.

### SUMMARY OF THE INVENTION

It is, therefore, an object of the present invention to provide a high efficiency DC to AC power converter capable of achieving zero voltage switching by provision of an inductive impedance in a conversion circuit.

It is another object of the present invention to provide a high efficiency DC to AC power converter capable of enhancing power conversion efficiency.

The high efficiency DC to AC power converter according to the present invention comprises a DC power generator, a filter/rectifier, a transformer, a lamp, a controller and an inductive impedance. The controller is used to activate or deactivate the filter/rectifier. The filter/rectifier is used to acquire and rectify and filter a DC power transmitted from the DC power generator. Then, the inductive impedance is used to convert an overall impedance into being inductive. Finally, the transformer converts the rectified and filtered DC power into an AC power. As such, the purpose of zero voltage switching is achieved and power conversion efficiency of the power converter is enhanced. The inductive impedance takes a form of a single inductance, an inductance and a capacitor connected in series therewith, an inductor, a capacitor and a resistor connected in series therewith, or an inductor, a capacitor and a resistor connected in series and parallel therewith. The filter/rectifier may be a half-wave rectifier or a full-wave rectifier.

### BRIEF DESCRIPTION OF THE DRAWINGS

The drawings disclose an illustrative embodiment of the present invention which serves to exemplify the various advantages and objects thereof, and are as follows:

FIG. 1 shows a half-wave conversion circuit for a conventional DC to AC power converter;

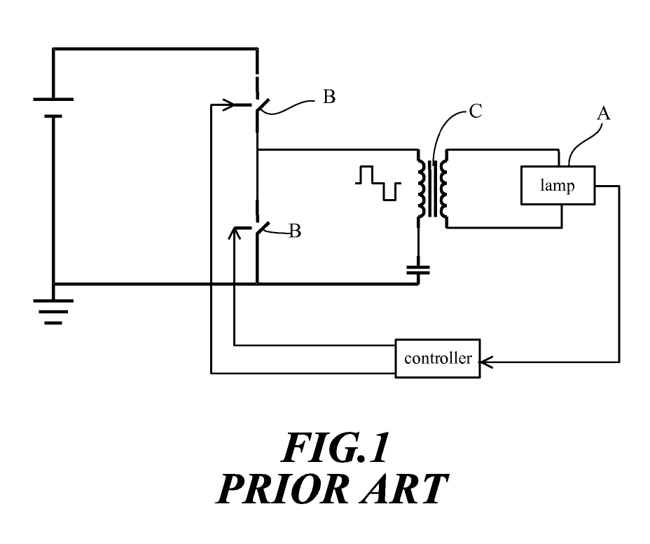

FIG. 2 shows a full-wave conversion circuit for the conventional DC to AC power converter;

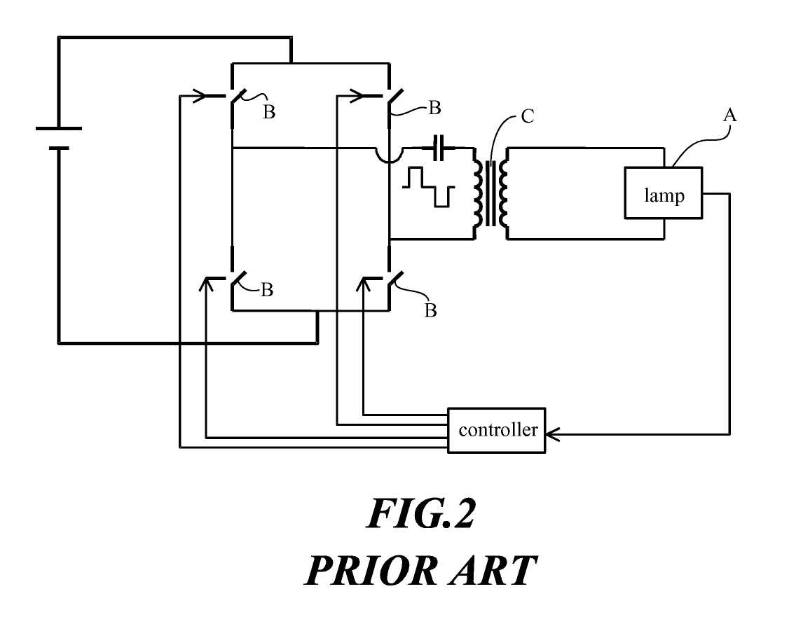

FIG. 3 shows a voltage versus current plot of the conventional DC to AC power converter;

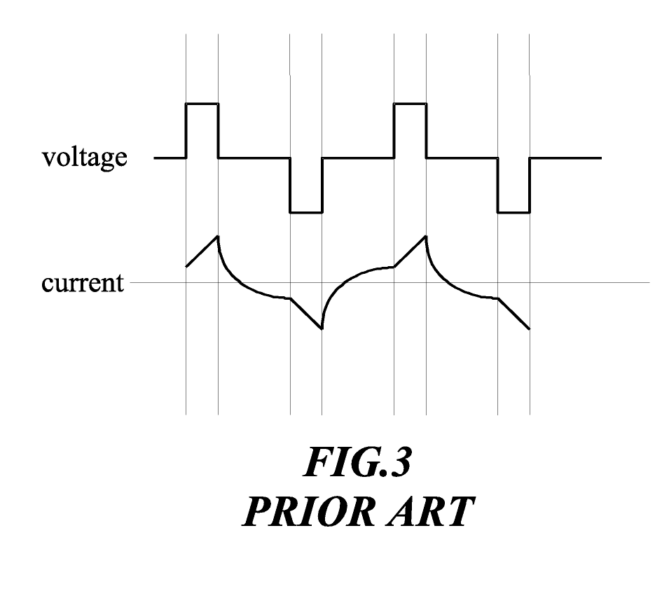

FIG. 4 shows a first conversion circuit form of a DC to AC power converter according to the present invention;

FIG. 5 shows a second conversion circuit form of the DC to AC power converter according to the present invention;

FIG. 6 shows a third conversion circuit form of the DC to AC power converter according to the present invention;

FIG. 7 shows a fourth conversion circuit form of the DC to AC power converter according to the present invention;

FIG. 8 shows a fifth conversion circuit form of the DC to AC power converter according to the present invention;

FIG. 9 shows a sixth conversion circuit form of the DC to AC power converter according to the present invention;

FIGS. 10A and 10B show forms of an inductive resistance provided in the conversion circuit of the high efficiency DC to AC power converter according to the present invention; and

FIG. 11 shows a voltage versus current plot of the high efficiency DC to AC power converter according to the present invention.

### DETAILED DESCRIPTION OF THE PREFERRED EMBODIMENT

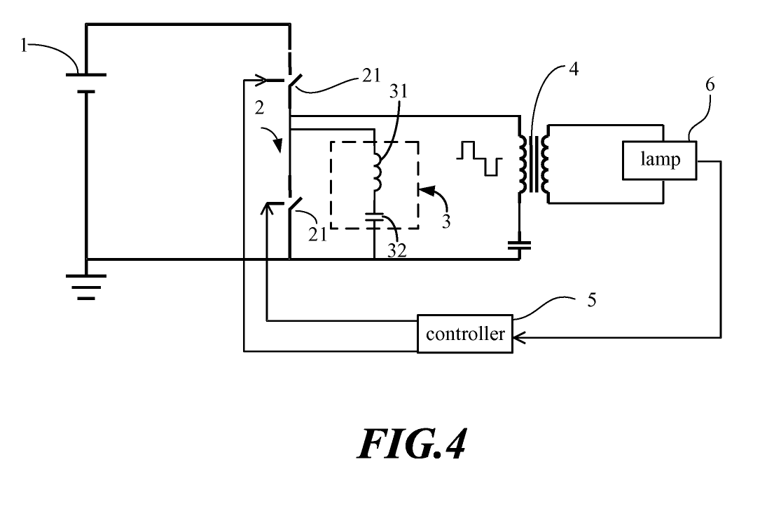

Referring to FIG. 4, a schematic diagram of a first conversion circuit for a high efficiency direct current (DC) to alternating current (AC) power converter according to the present invention is depicted therein. The first conversion circuit comprises a DC power generator 1, a half-wave rectifier 2, an inductive impedance 3, which is an inductor 31 connected in series with a capacitor 32, a transformer 4, a controller 5 and a lamp 6. The half-wave rectifier 2 is composed of two switches 21, which are operatively controlled by the controller 5 so that a DC power may be rectified and filtered. Specifically, a DC power transmitted from the DC power generator 1 is first acquired by the half-wave rectifier 2 and then the acquired DC power is rectified and filtered. Next, the inductive impedance 3 enables an overall impedance to be inductive. Finally, the rectified and filtered DC power is converted into an AC power through the transformer 4, the AC power being used as a power source of the lamp 6. In this manner, zero voltage switching may be achieved and thus power conversion efficiency of the DC to AC power converter may be enhanced.

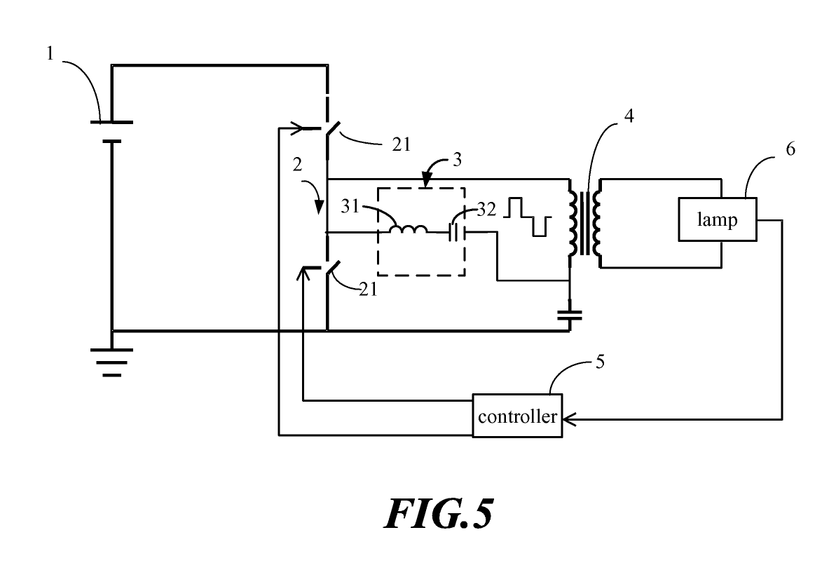

Referring to FIG. 5, the inductive resistance 3 may also be connected in parallel with the primary of transformer 4 to achieve zero voltage switching.

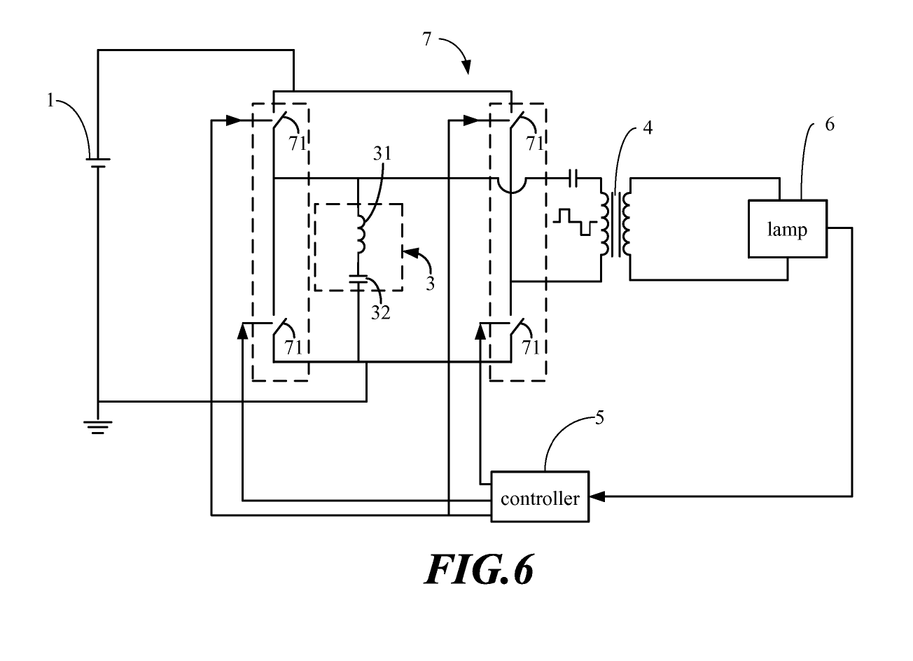

Referring to FIG. 6, in the case of the full-wave conversion circuit 7, the inductance impedance 3, which is an inductance 31 connected in series with a capacitor 32, may also be connected in parallel with the switch 71 and ground to achieve zero voltage switching.

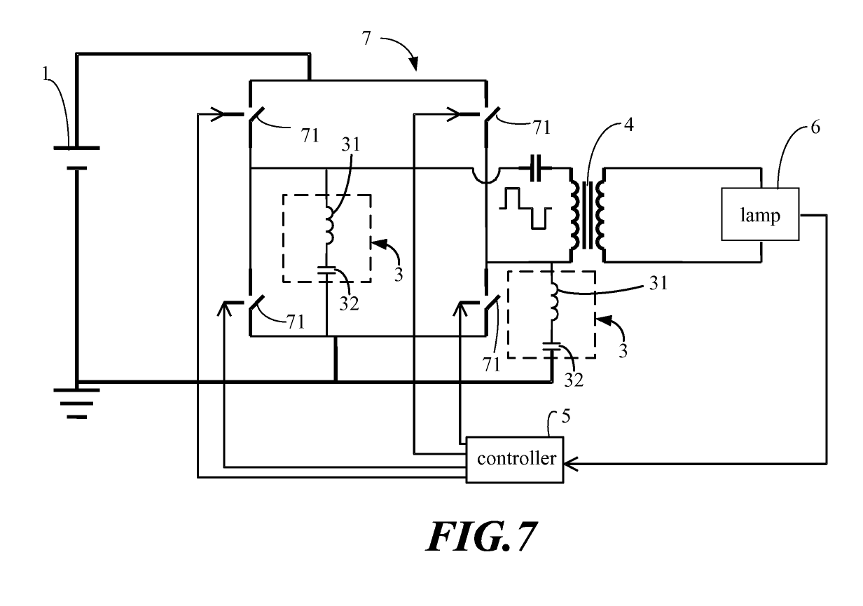

Referring to FIG. 7, in the case of the full-wave conversion circuit 7, the inductive impedance 3 may also be connected in parallel with switch 71 and ground to achieve zero voltage switching.

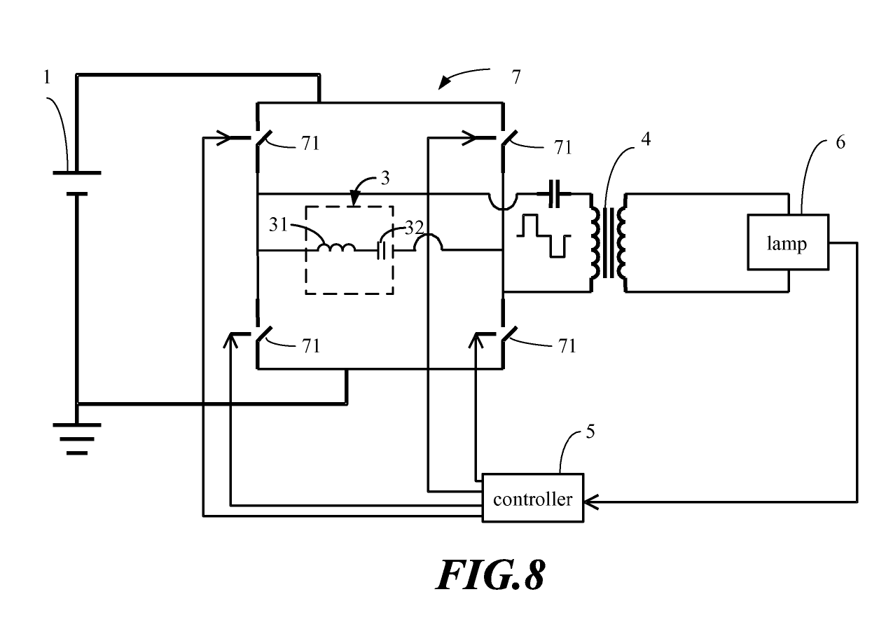

Referring to FIG. 8, in the case of the full-wave conversion circuit 7, the inductive impedance 3 may also be connected in parallel with switch 71 to achieve zero voltage switching.

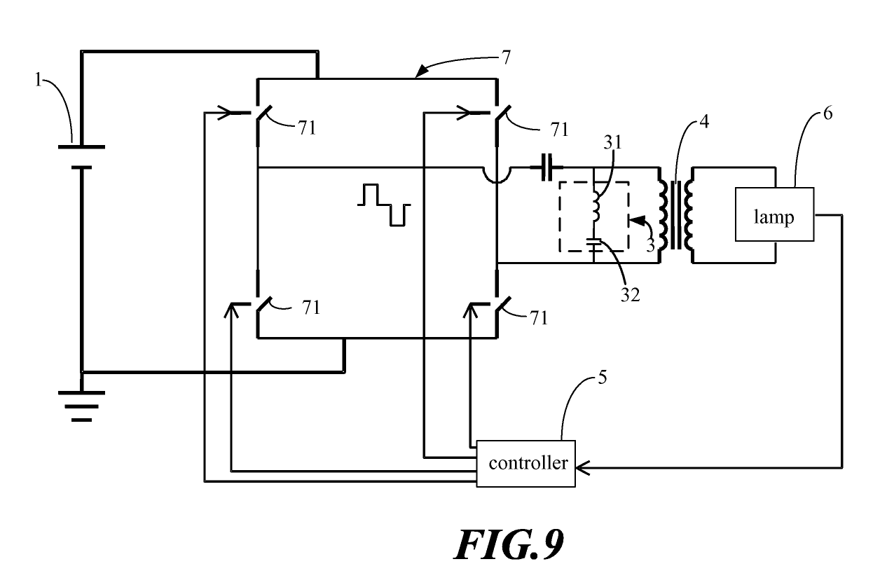

Referring to FIG. 9, in the case of the full-wave conversion circuit 7, the inductive impedance 3 may also be connected in parallel with the primary of transformer 4 to achieve zero voltage switching.

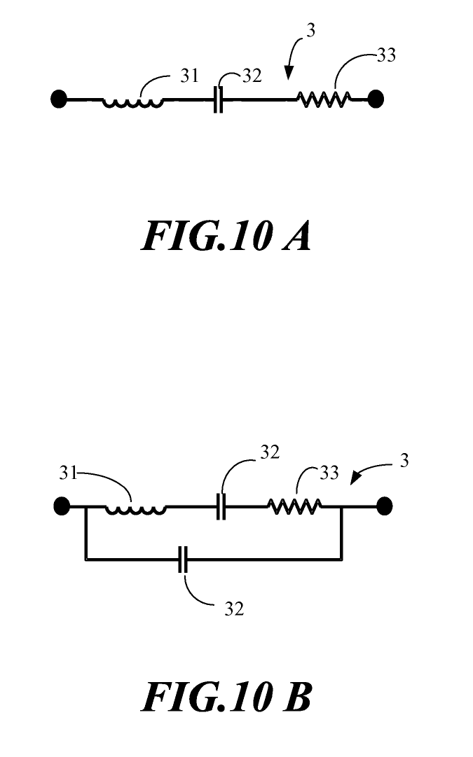

The inductive impedance 3 may take a form of an inductor 31, a capacitor 32 and a resistor 33 connected in series (shown in FIG. 10A), or an inductor 31, a capacitor 32 and a resistor 33 connected in series and parallel (shown in FIG. 10B).

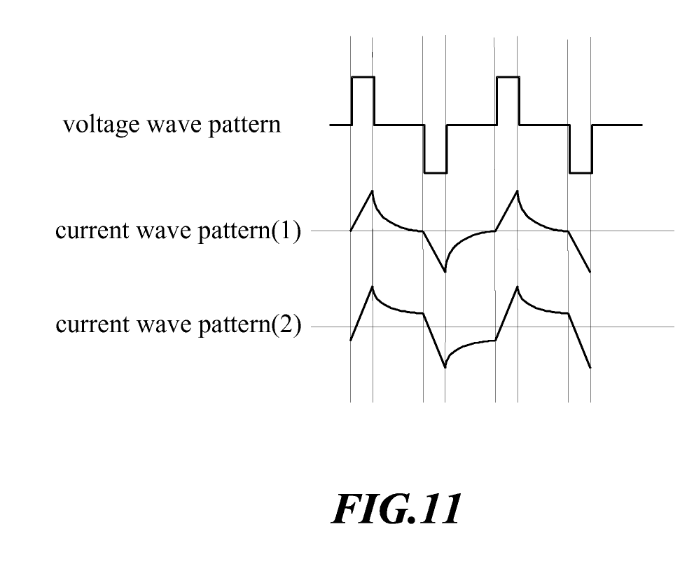

FIG. 11 shows a voltage versus current plot of the high efficiency DC to AC power converter with the inductive impedance provided. As shown, it may be readily appreciated that the purpose of zero voltage switching can be achieved by replacing the load with the inductive impedance. As such, power conversion efficiency may be enhanced. In conclusion, the high efficiency DC to AC power converter of this invention provides the advantage of zero voltage switching by providing an inductive impedance, which the prior art does not.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A high efficiency DC to AC power converter comprising:
a transformer having a primary winding and a secondary winding coupled to an AC load;
a switching network having an input coupled to a DC power source and an output coupled to the primary winding, the switching network having at least two switching devices alternately driven to provide a pulsed output to the primary winding; and
an inductive impedance circuit, which includes an inductor connected in series with a capacitor, connected to a node coupling the at least two switching device together and coupled to a reference potential to provide zero voltage switching of the switching devices.

2. The high efficiency DC to AC power converter according to claim 1, wherein the inductive impedance circuit further includes a resistor connector in series with the inductor and the capacitor

3. The high efficiency DC to AC power converter according to claim 2, wherein the inductive impedance circuit further includes another capacitor connected in parallel with the inductor, the capacitor and the resistor.

4. The high efficiency DC to AC power converter according to claim 1, wherein the inductive impedance circuit is connected between a switch and ground when the conversion circuit is a half-wave conversion circuit.

5. The high efficiency DC to AC power converter according to claim 1, wherein the inductive impedance circuit is connected between a single end and ground when the conversion circuit is a full-wave conversion circuit.

6. The high efficiency DC to AC power converter according to claim 1, wherein the switching network includes two pairs of switching devices coupled in bridge circuit and the inductive impedance circuit is connected to the node between one of the pairs of switching devices and coupled to the reference potential and further comprising a second inductive impedance circuit connected to a node between the other pair of switching devices and the reference potential.

7. The high efficiency DC to AC power converter according to claim 1, wherein the inductive impedance is coupled to the reference potential through a switching device of the switching network.
